(19) United States
(12) Patent Application Publication
(10) Pub. No.: US 2003/0130043 A1
(43) Pub. Date: Jul. 10, 2003

(54) Video game management system with surge protection

(76) Inventor: Arthur Joseph Blake JR., Leominster, MA (US)

Correspondence Address: MINTZ, LEVIN, COHN, FERRIS,, GLOVSKY and POPEO, P.C., One Financial Center, Boston, MA, 02111, US

(21) Appl. No.: 10/044,157

(22) Filed: Jan. 9, 2002

(51) Int. Cl. A63F 13/00

(52) U.S. Cl. 463/46; 463/47

(57) ABSTRACT

Aspects of the present invention are directed to methods and apparatus for providing a power strip with surge suppression, game controller storage with cord management and CD, DVD, game disk and memory card storage. A game console storage unit is provided which includes a power strip with surge suppression for powering a video game console as well as other devices for storing . . . . The invention can exist in several configurations including a single storage bay or combinations of multiple storage bays. In some configurations the storage bays are removable and or transportable.

### FIELD OF THE INVENTION

The present invention is directed generally to storage units for use with video game consoles for storing video games, video game controllers, memory cards and other accessories and more particularly to storage units incorporating a power strip and surge protection for providing power and surge protection for video game consoles and other electronic equipment.

### BACKGROUND OF THE INVENTION

Home entertainment systems often include video game systems and other expensive pieces of electronic equipment. Much of this equipment is typically connected to an AC power source. Additionally, certain elements of these systems are often connected to the Internet or other network through Ethernet, coaxial, telephone or other types of cabling. Therefore, these systems are susceptible to power surges and signal line disturbances due to lighting and power fluctuations.

In addition, video game systems typically include video game consoles, game controllers, game disks, memory cards and other various components. Many of these systems, however, fail to provide adequate or appropriate storage means for these various video game components. As the number of various components increase, so too does the need for a system for managing and storing them.

There are several prior art surge protection devices for protecting home entertainment systems and other types of electronic equipment. In addition, other systems exist for storing the various components of a video game system. A need exists for a combination system that is capable of both protecting home entertainment systems from power surges and that will also provide adequate storage for the various components that typically accompany these systems, including the video game components listed above as well as DVD's, CD-ROM's, etc.

### SUMMARY OF THE INVENTION

In embodiments of the present invention, in order to overcome these and other shortcomings, a different approach has been taken; a game management system is provided that provides surge protection to a video game console and other home entertainment equipment as well as provide storage means for storing video game disks, memory cards, DVD's, CD-ROM's, game controllers and other accessories.

In one aspect, the present invention is directed to a video game management system. The video game management system includes at least one storage module, wherein the storage module is constructed and arranged to store at least one disk and or may store at least one memory card and at least one controller clip, wherein the controller clip is configured to cradle a video game controller.

The video game management system may be constructed and arranged such that the controller clip is configured to accept a video game controller cord. The video game management system may be constructed and arranged such that the controller clip is removable. The video game management system may be constructed and arranged such that the storage module is constructed and arranged to store one or more DVD, CD-ROM and or video game disks. The video game management system may be constructed and arranged such that the storage module is removable from the game storage unit. The video game management system may be constructed and arranged such that the storage module includes a closable door. The video game management system may be constructed and arranged such that the storage module further includes a label. The video game management system may be constructed and arranged to store one or more DVD, CD-ROM, memory card and or video game disks in their original cases.

The video game management system may be constructed and arranged to further include a surge suppression system, wherein the surge suppression system is constructed and arranged to provide surge protected power to one or more electronic devices. The video game management system may be constructed and arranged such that the surge suppression system includes one or more surge protected power outlets. The video game management system may be constructed and arranged such that the surge suppression system includes a power on and or a surge protection status light. The video game management system may be constructed and arranged such that the surge suppression system provides surge protection to one or more electronic devices through at least one jack. The video game management system may be constructed and arranged such that the surge suppression system further includes at least one coaxial cable jack and or at least one RJ 45 jack and or at least one RJ 11 jack. The video game management system may be constructed and arranged to correspond with a specific video game console.

In another aspect, the present invention is directed to a video game management system wherein the video game management system includes a main housing, a surge suppression system disposed within the housing, wherein the surge suppression system is constructed and arranged to provide surge protected power to one or more electronic devices and at least one storage module disposed within the housing, wherein the storage module is constructed and arranged to store at least one disk and or at least one memory card. The video game management system may be constructed and arranged such that the storage module is removable from the housing. The video game management system may further be constructed and arranged to store one or more DVD, CD-ROM and or video game disks. The video game management system may further be constructed and arranged such that the storage module includes one or more sliding trays that are constructed and arranged for storing a disk and or may store a memory card. The video game management system may be constructed and arranged wherein the storage module further includes a door. The video game management system may be constructed and arranged wherein the storage module further includes a label. The video game management system may be constructed and arranged to store one or more DVD, CD-ROM, memory card and or video game disks in their original cases. The video game management system may be constructed and arranged such that the surge suppression system is constructed and arranged to provide surge protection to one or more electronic devices through at least one jack. The video game management system may be constructed and arranged to further include at least one coaxial cable jack and or at least one RJ 45 jack and or at least one RJ 11 jack. The video game management system may be constructed and arranged to further include at least one controller clip, wherein the controller clip is configured to cradle a video game controller. The video game management system may be constructed and arranged such that the controller clip is configured to accept a video game controller cord. The video game management system may be constructed and arranged to correspond with a specific video game console. The video game management system may be constructed and arranged such that certain features of the video game management system are accented in a color that corresponds with a specific video game console.

In yet another aspect, the present invention is directed to a video game management system wherein the video game management system includes storage means for storing video game components and surge protected power means for providing surge protected power to at least one electronic device.

In yet another aspect, the present invention is directed to a video game management system wherein the video game management system includes a housing, wherein the housing is constructed and arranged to provide a thermal barrier between a video game console or other electronic device and a surface of an object and a surge suppression system disposed within the housing, wherein the surge suppression system is constructed and arranged to provide surge protected power to one or more electronic devices.

The video game management system may be further constructed and arranged such that certain features of the video game management system are constructed and arranged to correspond with a specific video game console. The video game management system may be further constructed and arranged such that certain features of the video game management system are accented in a color that corresponds with a specific video game console. The video game management system may be further constructed and arranged to include at least one storage module, wherein the storage module is constructed and arranged to store at least one disk and or at least one memory card. The video game management system may be further constructed and arranged such that the storage module is constructed and arranged to store one or more DVD, CD-ROM and or video game disks. The video game management system may be further constructed and arranged such that the storage module is removable.

### BRIEF DESCRIPTION OF THE DRAWINGS

For a better understanding of the present invention, reference is made to the drawings, which are incorporated herein by reference, and in which:

FIG. 1 is a perspective view of a video game management system in accordance with a first embodiment of the present invention;

FIG. 2 is a perspective view of the video game management system of FIG. 1 showing a game controller clipped to the attached to video game management system;

FIG. 3 is a perspective view of the video game management system of FIG. 1 showing various features of the storage modules;

FIG. 4 is a perspective view of the video game management system of FIG. 1 showing optional mounting feet;

FIG. 5 is a perspective view of an alternative embodiment of the video game management system;

FIG. 6a is a rear view of the video game management system in accordance with an embodiment of the present invention;

FIG. 6b is a blown-up view of the RJ-45 connection jack of FIG. 6a;

FIG. 6c is a blown-up view of the coaxial cable connections of FIG. 6a; and

FIG. 7 is a schematic diagram of a surge protection circuit in accordance with an embodiment of the present invention.

### DETAILED DESCRIPTION

For purposes of illustration only, and not to limit generality, the present invention will now be described with reference to video game management systems for use with video game consoles, such as the PlayStation1 and PlayStation2 video game consoles sold under the trademark SONY, the XBOX video game console sold under the trademark MICROSOFT and the Nintendo 64 or Super Nintendo sold under the trademark NINTENDO. One skilled in the art, however, will appreciate that embodiments of the present invention are not limited to video game management systems. The present invention may also serve as a combination surge protection and storage device system for other electronic devices, such as a TV, VCR, DVD or CD-ROM player, wherein the system can provide surge protection to one or more electronic devices and can accommodate several types of disks (e.g., CD's, DVD's etc.) and other accessories.

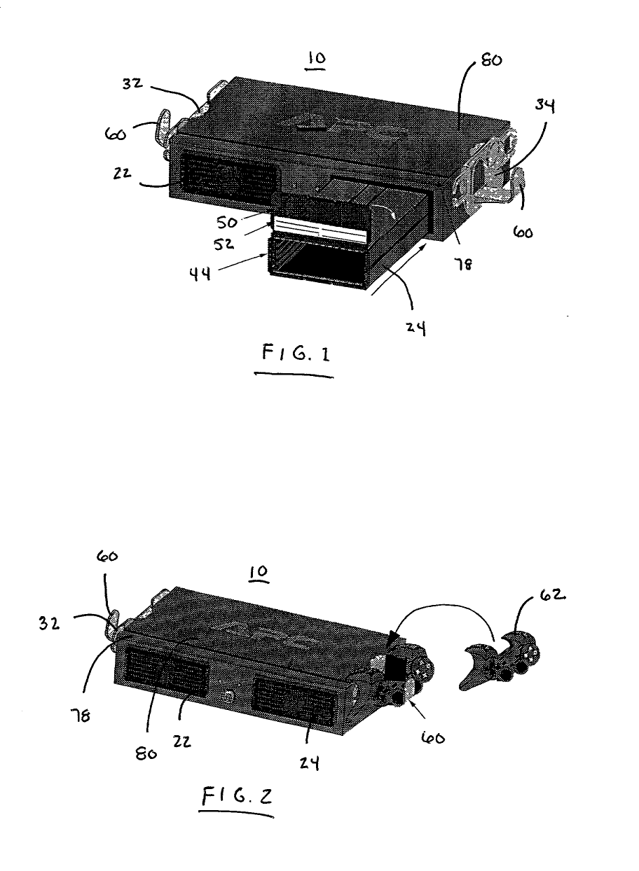

FIGS. 1-3 show a first embodiment of a video game management system 10, which includes a housing 12 and a pair of removable game storage modules 22, 24, for storing video game disks outside of their original case. The game storage modules 22, 24 are removably housed in a pair of game manager bays 26, 28 and may be used to safely store and transport several video game disks, CD-ROM's, DVD's and or memory cards from one location to another. In this and the following embodiments, the game management system 10 is shown in a horizontal orientation, however, it is contemplated that the game management system 10 may also be oriented vertically.

The game storage modules 22, 24 each include a number of spring loaded disk trays 40 for storing video game disks 42. It should be noted that the disk trays 40 are configured to store other types of disks, such as CD-ROM's, DVD's, etc. Each disk tray 40 also includes a spring wire (not shown) attached to the back of the disk tray. The video game management system 10 also includes a plurality of numbered tray release tabs 44, which trigger the release of a corresponding disk tray 40. With the disk tray 40 extending out from the game storage modules 22, 24 the video game disk 42 is placed on the disk tray face 46 and then the tray 40 is pushed back into the storage module 22, 24 until it snaps in place. In the present embodiment, each game storage module can safely hold up to eleven video game disks 42 outside their original case. Other storage modules are contemplated for holding additional or fewer disks.

In certain embodiments, the game storage modules 22, 24 also include a memory card tray 54 having four slots 58 for storing up to four memory cards 56. The memory card tray 54 is released in the same manner as the disk trays 40. Because not all memory cards 56 are of the same thickness, one or more trays above the memory card tray 54 may be removed to accommodate thicker memory cards. In addition, because not all memory cards are the same size, variations in the size and number of slots 58 are contemplated. Also, the number and arrangement of disk trays 40 and memory card trays 54 in each game storage module may be adjusted to accommodate a variety of disk and memory card configurations.

In embodiments of the present invention, the game storage modules 22, 24 include module covers 50. The module covers 50 protect the video game disks 42 and the memory cards 56 when the storage module is either in or out of the video game management system 10. In some embodiments, the module cover 50 is a molded door that closes to protect and contain the disks during travel, which may be folded back and out of the way when the game storage modules 22, 24 are inserted into the video game management system 10.

In certain embodiments, the module covers 50 may include labels 52 for listing the video game disks 42 and the memory cards 56 stored within the game storage modules 22, 24. A clear plastic strip 78, located on a surface 80 of the video game management system 10, allows the user to read entries on the label 52, without having to remove the game storage modules from their storage bays.

In certain embodiments, the video game management system 10 also includes a pair of optional and or removable video game controller clips 32, 34, which provide storage for up to two video game controllers 62, while keeping their cords from getting tangled. The controller clips 32, 34 each include a hook 60 for storing a video game controller 62 and a set of chassis tabs 64, 66 about which a video game controller cord (not shown) may be wrapped when not in use.

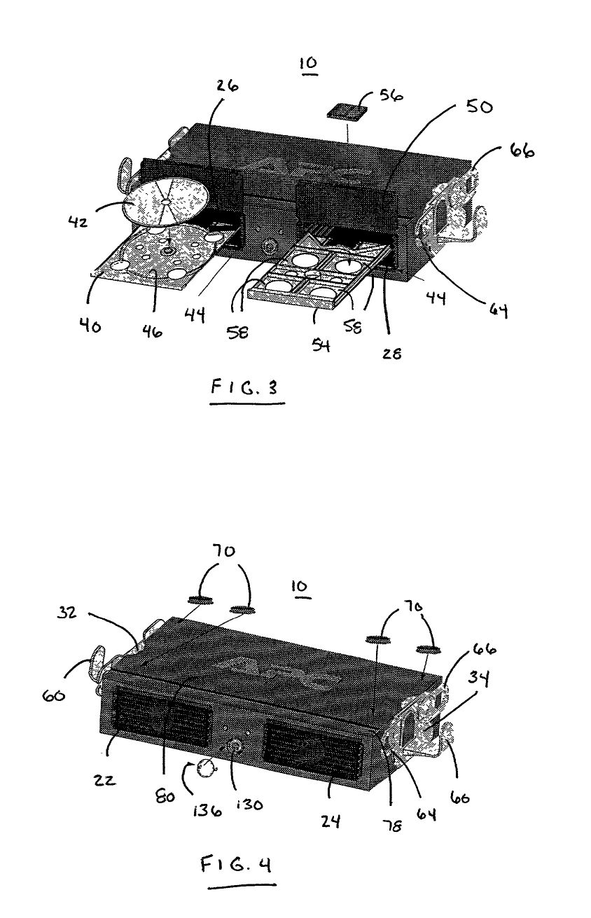

Additionally, the sets of chassis tabs 64, 66, about which the controller cord is wrapped, also serve strain relief and protection from disconnect functions. When the controller cord is threaded through the pincer fingers 68 of the chassis tabs 64, 66 by displacing the fingers enough to allow the cord to pass through, the pincers 68 act as a strain relief, absorbing some force imparted by accidental or unintended pulling on the controller cord. This feature of the present invention prevents accidental disconnect of the controller cords during excited game play. Referring now to FIG. 4, in this and other embodiments, the video game management system may be used as a platform for various game consoles and other components of a home entertainment system. For example, a set of optional mounting feet 70 may be placed on the top surface 80 of the video game management system 10. When installed, the mounting feet 70 allow a game console (not shown) to be safely and securely placed on top of the video game management system 10. The mounting feet 70 allow airflow between the video game management system 10 and the video game console, which helps to dissipate heat between the devices. The mounting feet 70 also serve to prevent slippage between the game management system 10 and a game console, thereby keeping the units neatly stacked with one another.

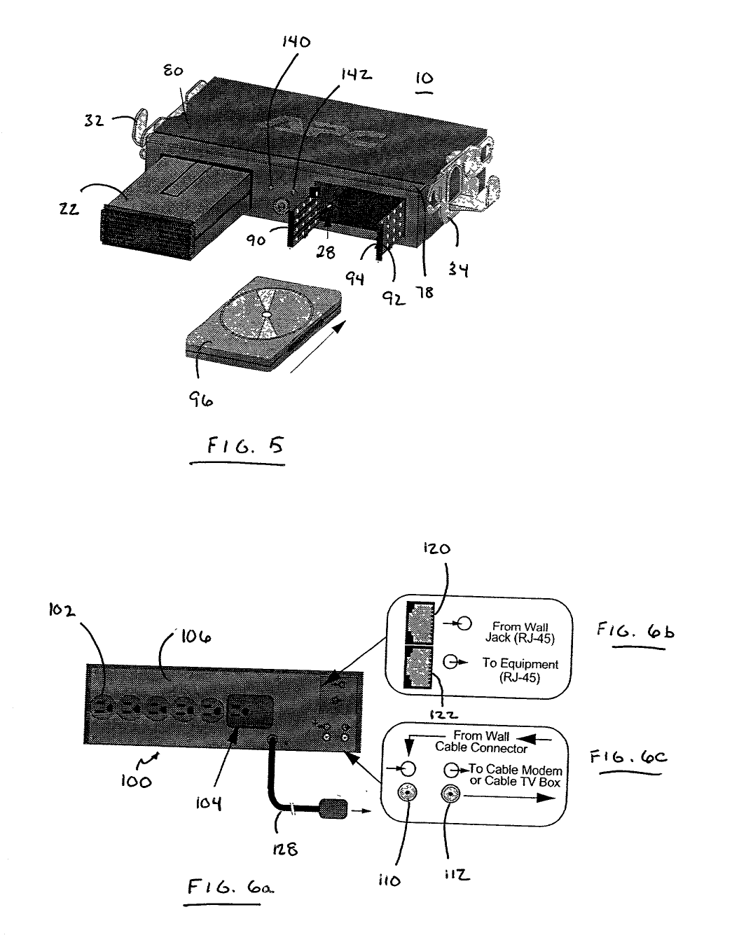

FIG. 5 shows another embodiment of the present invention, wherein the video game management system 10 is configured for storing video game disks 42 in their original cases 96. In this embodiment, one or both of the game storage modules 22, 24 is removed from the game manager bays 26, 28 and a pair of guide rails 90, 92 are placed in the game manager bays 26, 28 in their place. As shown, guide rails 90, 92 form a series of four slots 94, wherein each slot 94 can accommodate a video game in its original case 96. The guide rails 90, 92 may also be configured for storing CD-ROM and DVD disks in their original cases as well.

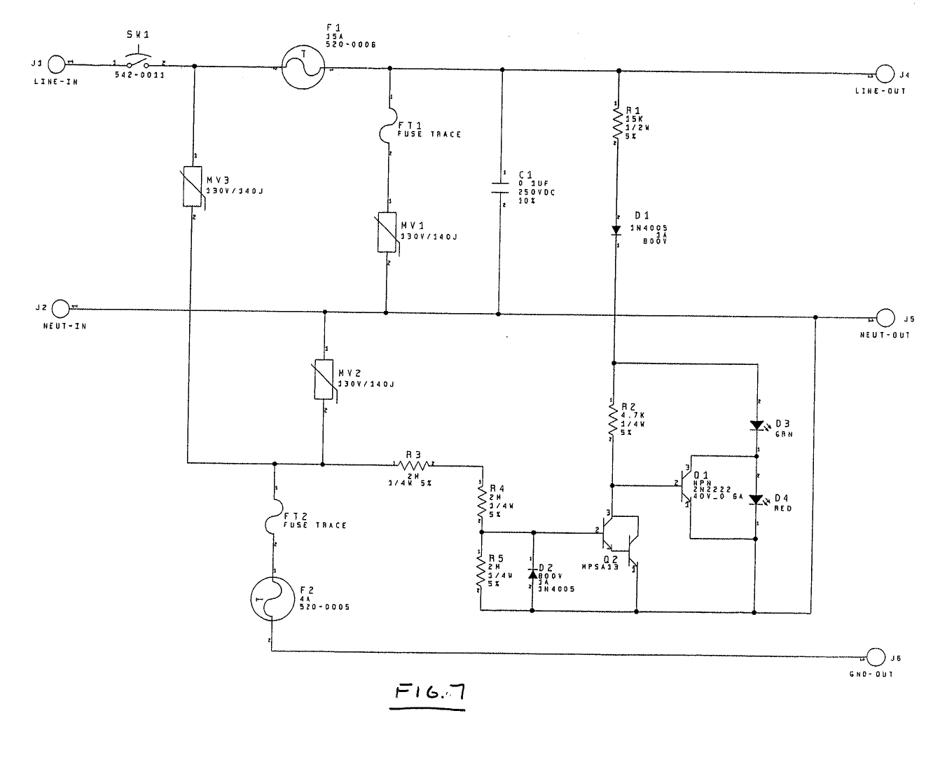

FIGS. 6a-6c show an optional surge protection module 100 mounted in the back end 106 of the video game management system 10. The surge protection module 100 includes a series of power outlets 102, which may be used to supply surge protected power to a video game console and additional devices, such as a television, DVD player, CD player, etc. In this embodiment, the surge protection module 100 includes an additional outlet 104 for accommodating a device having a transformer block.

The surge protection module 100 also includes surge protected coaxial jacks 110, 112, which may be used to protect a cable modem, cable television box, gaming equipment or other equipment that requires a coaxial cable connection. To protect a piece of equipment requiring a coaxial connection, a coaxial cable is connected from a wall jack (not shown) to coaxial jack 110. Then, using a separate cable, the piece of equipment is then connected to coaxial jack 112.

Also shown in this embodiment, because it may be desirable to connect a video game module or other device to the Internet or other network using a 10-Base T or 100-Base T cable (not shown), the surge protection module 100 includes surge protected RJ-45 jacks 120, 122. The RJ-45 jack 120 is used to connect the video game management system 10 to a wall or similar type jack (not shown) and the RJ-45 jack 122 is used to connect the video game management system 10 to the piece of equipment to be protected.

In other embodiments, it is contemplated that other jacks may be employed for providing surge protection for other types of cabling. For example, RJ-11 or telephone type jacks (not shown) may be used for connecting phone lines or other similar type cabling to and from the game management system.

The video game management system 10 includes a power cord 128 for connecting the system to a power source (not shown) and a power switch circuit breaker 130 (See FIGS. 2-5), which provides power to outlets 102, 104 and other surge protected receptacles and acts as a circuit breaker to protect against overload conditions. The video game management system 10 further includes a removable on/off switch guard 136, which helps to prevent accidental turn offs.

The video game management system 10 may further include various indicators that alert a user to the status of power and or surge protection capabilities. For example, a protection-working indicator 140 illuminates when the video game management system 10 is turned on and the surge protection module 100 is functioning properly, thereby protecting connected equipment from harmful power surges. In certain embodiments, the surge protection capabilities of the surge protection module 100 continue to operate when the video game management system 10 is turned off. The video game management system 10 may also include a site wiring fault indicator 142, which indicates when lit that there is an issue with the building wiring, such as an improper building ground, which may present a potential shock hazard and or may limit the protection features of the surge protection module 100.

In certain embodiments of the present invention, the video game management system 10 may be configured to correspond with a specific video game console or other electronic devices. For example, the size, shape and color of housing 12 may be constructed and arranged to interrelate with the dimensions and appearance of any of a number of video game consoles. Also, certain other features of the video game management system 10, such as the video game controller clips 32, 34, the clear plastic strip 78 and the on/off switch guard 136 may be colored or otherwise accented to highlight or interrelate with certain colors and features of specific video game consoles (e.g., they may be made blue for use with the SONY PlayStation, green for use with the MICROSOFT XBOX, or purple for use with NINTENDO brand Nintendo 64 or Super Nintendo consoles. Additionally, certain markings or labels may be affixed to the video game management system 10 to further relate to a specific electronic device.

FIG. 7 shows a schematic diagram of a surge suppression system of one embodiment of the present invention. Although a typical surge suppression system is described, one skilled in the art will appreciate that alternative power protection designs may be employed that include, for example line-conditioning capabilities. Alternatively, a power station or power manager (not shown) may be used to protect the video game console or other equipment from unwanted power surges as well as allowing for separate on off features, with some, all or none of the components contained within the video game management system 10.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A video game management system comprising:
at least one storage module, wherein the storage module is constructed and arranged to store at least one disk and or at least one memory card; and
at least one controller clip, wherein the controller clip is configured to cradle a video game controller.

2. The video game management system of claim 1, wherein the controller clip is constructed and arranged to accept a video game controller cord.

3. The video game management system of claim 1, wherein the controller clip is removable.

4. The video game management system of claim 1, wherein the storage module is constructed and arranged to store one or more DVD, CD-ROM and or video game disks.

5. The video game management system of claim 1, wherein the storage module is removable.

6. The video game management system of claim 1, wherein the storage module includes a closable door.

7. The video game management system of claim 1, wherein the storage module further includes a label.

8. The video game management system of claim 1, wherein the video game management system is constructed and arranged to store one or more DVD, CD-ROM, memory card and or video game disks in their original cases.

9. The video game management system of claim 1, further comprising a surge suppression system, wherein the surge suppression system is constructed and arranged to provide surge protected power to one or more electronic devices.

10. The video game management system of claim 9, wherein the surge suppression system includes one or more surge protected power outlets.

11. The video game management system of claim 9, further comprising a power on and or a surge protection status light.

12. The video game management system of claim 9, wherein the surge suppression system further provides surge protection to one or more electronic devices through at least one jack.

13. The video game management system of claim 12, further comprising at least one coaxial cable jack and or at least one RJ 45 jack and or at least one RJ 11 jack.

14. The video game management system of claim 1, wherein certain features of the video game management system are constructed and arranged to correspond with a specific video game console.

15. A video game management system comprising:
a main housing;
a surge suppression system disposed within the housing, wherein the surge suppression system is constructed and arranged to provide surge protected power to one or more electronic devices; and
at least one storage module disposed within the housing, wherein the storage module is constructed and arranged to store at least one disk and or at least one memory card.

16. The video game management system of claim 15, wherein the storage module is removable from the housing.

17. The video game management system of claim 15, wherein the storage module is constructed and arranged to store one or more DVD, CD-ROM and or video game disks.

18. The video game management system of claim 15, wherein the storage module further includes one or more sliding trays that are constructed and arranged for storing a disk and or a memory card.

19. The video game management system of claim 15, wherein the storage module further includes a door.

20. The video game management system of claim 15, wherein the storage module further includes a label.

21. The video game management system of claim 15, wherein the video game management system is constructed and arranged to store one or more DVD, CD-ROM, memory card and or video game disks in their original cases.

22. The video game management system of claim 15, wherein the surge suppression system further provides surge protection to one or more electronic devices through at least one jack.

23. The video game management system of claim 22, further comprising at least one coaxial cable jack and or at least one RJ 45 jack and or at least one RJ 11 jack.

24. The video game management system of claim 15, further comprising at least one controller clip, wherein the controller clip is configured to cradle a video game controller.

25. The video game management system of claim 24, wherein the controller clip is constructed and arranged to accept a video game controller cord.

26. The video game management system of claim 15, wherein certain features of the video game management system are constructed and arranged to correspond with a specific video game console.

27. The video game management system of claim 15, wherein certain features of the video game management system are accented in a color that corresponds with a specific video game console.

28. A video game management system for use with a video game console comprising:
storage means for storing video game components; and
surge protected power means for providing surge protected power to at least one electronic device.

29. A video game management system comprising:
a housing, wherein the housing is constructed and arranged to provide a thermal barrier between a video game console or other electronic device and a surface of an object; and
a surge suppression system disposed within the housing, wherein the surge suppression system is constructed and arranged to provide surge protected power to one or more electronic devices.

30. The video game management system of claim 29, wherein certain features of the video game management system are constructed and arranged to correspond with a specific video game console.

31. The video game management system of claim 29, wherein certain features of the video game management system are accented in a color that corresponds with a specific video game console.

32. The video game management system of claim 29, further comprising at least one storage module, wherein the storage module is constructed and arranged to store at least one disk and or at least one memory card.

33. The video game management system of claim 29, wherein the storage module is constructed and arranged to store one or more DVD, CD-ROM and or video game disks.

34. The video game management system of claim 29, wherein the storage module is removable.
